(19) United States
(12) Patent Application Publication
(10) Pub. No.: US 2019/0336801 A1
(43) Pub. Date: Nov. 7, 2019

(54) SMOKE SCREEN APPARATUS WITH MANUAL EGRESS CAPABILITY

(71) Applicant: Smoke Guard, Inc., Boise, ID (US)

(72) Inventors: Steven Alan Edwards, Boise, ID (US); Herb Kaup, Boise, ID (US)

(21) Appl. No.: 16/402,046

(22) Filed: May 2, 2019

Related U.S. Application Data
(60) Provisional application No. 62/819,853, filed on Mar. 18, 2019.
(60) Provisional application No. 62/762,428, filed on May 3, 2018.

(51) Int. Cl. A62C 2/10; E06B 9/13; E06B 9/58; E06B 9/72; E06B 9/17

(52) U.S. Cl. CPC A62C 2/10; E06B 9/13; E06B 9/17046; E06B 9/72; E06B 9/17007; E06B 9/581

(57) ABSTRACT

This disclosure relates generally to a smoke screen apparatus for shielding humans from harmful exposure to smoke, noxious fumes, or contaminated air. For safety reasons the smoke screen must allow for manual egress through the screen using a release mechanism that can automatically recover to the protective state after egress.

### CROSS-REFERENCE TO RELATED APPLICATION(S)

This non-provisional patent application claims the benefit of and priority to U.S. Provisional Patent Application No. 62/819,853 filed on Mar. 18, 2019, titled “Smoke Screen Apparatus with Manual Egress Capability,” and U.S. Provisional Patent Application No. 62/762,428 filed on May 3, 2018, titled “Smoke Screen Apparatus with Manual Egress Capability,” both of which are incorporated herein by reference.

### TECHNICAL FIELD

Embodiments of the present invention are directed to smoke screen apparatus for shielding humans from harmful exposure to smoke, noxious fumes or contaminated air, and more particularly to deployable smoke screen apparatus configured to allow for manual egress.

### BACKGROUND

In order to protect humans against smoke or fumes in a structure that may be undergoing a fire event, many different types of isolation devices have been developed over the years. These devices are intended to seal off certain openings through which smoke or fumes are likely to travel. In high-rise structures (e.g. office buildings or apartment buildings) it is important to seal off elevator openings since their shafts and openings are a key way that smoke can migrate from one floor to other floors in the structure. However, it is also important that after a smoke screen is deployed (e.g. lowered from above an elevator opening) that the screen be movable to allow people to pass through the screened opening. The screen should then automatically recover and reseal to ensure that smoke migration does not occur.

One system for sealing off elevators is the M800 product from Smoke Guard of Boise, Idaho. This product is described to a certain extent in U.S. Pat. Nos. 5,195,594 and 5,383,510 (which are incorporated herein by reference). Screens such as the M800 from Smoke Guard use a heat resistant film that is captured along the vertical and horizontal edges and detachably constrained into a metallic frame around an elevator opening. When not in use, the screen assemblies are rolled up into a tight cylindrical form and retracted upward into an enclosure, usually a hidden housing assembly in the ceiling above the protected opening.

In the prior art, the attachment mechanism used by those skilled in the art is either magnetically captured or non-detachable. For non-detachable screens, manual egress through the screen system is not possible. Several existing solutions claim to have manual egress, however, upon further review, these solutions are using electrically activated mechanisms or lifting aids that severely restrict the usable egress area.

What is desirable is a manual egress screen system that is simple to use, does not require electrical activation or lifting aids (e.g. handles) for egress, and will automatically retract and then recover to the protected state (i.e. deployed state over the opening).

### SUMMARY

The apparatus and method of the current technology overcomes drawbacks experienced in the prior art and provide additional benefits. Embodiments of the apparatus and methods described herein will enable full ADA compliant egress from a protected zone, while maintaining required sealing and pressurization capability per applicable building codes. Further, after a designed breach of the sealed screen to permit easy and quick manual egress, the system will detect the breach and automatically recover to the sealed, deployed protective state.

At least some of the current technology's benefits over magnetically captured screen products are provided in additional architectural finishing options enabled by the small profile enclosable side guides that capture and guide the side edges of the screen during movement between deployed and retracted positions. Magnetic products rely on having exposed elevator frames or auxiliary stainless-steel side rails for the flux return path for attraction, and thereby sealing. The exposed frames needed in the prior art systems are often contrary to overlay finishing desired in some artistic renderings. The current technology is not restricted by such limitation.

At least one embodiment of the present technology provides a smoke screen apparatus comprising a side guide having an elongated channel at least partially defined by at least one moveable elongated member, and a flexible heat resistant film forming a deployable smoke screen. The flexible heat resistant film has an enlarged side edge sized to slidably fit inside the elongated channel when the screen is in a deployed position. The smoke screen apparatus is configured to allow manual push-through egress when the screen is deployed and when a sufficient pressure is exerted on the flexible heat resistant film, so that the screen's enlarged edge causes the elongated moveable member of the side guide to pivot in such a way that the enlarged edge exits the elongated channel. When a portion of the enlarged side edge is released from the side guide, the enlarged edge and a portion of the heat resistant film can be pivoted or otherwise moved forwardly or rearwardly away from the side guide to form an egress opening therebetween.

In another embodiment, a smoke screen apparatus has a headbox assembly, and a smoke screen coupled to the headbox assembly. The smoke screen has a flexible heat resistant film and at least one enlarged side edge coupled to a side portion of the film. The smoke screen is movable between deployed and retracted positions. The smoke screen is contained in the headbox assembly when in the retracted position. Opposing side guides are adjacent to the headbox assembly and coupled to the smoke screen. The side guides engage the smoke screen during movement to the deployed position. At least a first side guide has a guide base with an elongated channel therein configured to slidably receive the enlarged side edge. The first side guide has a moveable elongated member connected to the guide base and at least partially covering the elongated channel to releasably retain the enlarged side edge portion therein during movement of the smoke screen between the stowed and retracted positions. The elongated member is movable relative to the guide base between a closed, retaining position and an open, released position. The enlarged edge is slidably retained in the channel when the elongated member is in the closed, retaining position. The enlarged edge is movable out of the channel when the elongated member is in the open, released position.

In another embodiment, a smoke screen apparatus has a headbox assembly, and a smoke screen coupled to the headbox assembly. The smoke screen has a flexible heat resistant film and at least one enlarged side edge coupled to a side portion of the film. The smoke screen is movable between deployed and retracted positions. The smoke screen is contained in the headbox assembly when in the retracted position. Opposing side guides are adjacent to the headbox assembly and coupled to the smoke screen. The side guides engage the smoke screen during movement to the deployed position. At least a first side guide has a guide base with an elongated channel therein configured to slidably receive the enlarged side edge. The first side guide has a moveable elongated member connected to the guide base and at least partially covering the elongated channel to releasably retain the enlarged side edge portion therein during movement of the smoke screen between the stowed and retracted positions. The elongated member is movable relative to the guide base between a closed, retaining position and an open, released position. A biasing member is coupled to the elongated member and configured to urge the elongated member toward the closed, retaining position. The first side guide has a recovery opening in communication with the channel. The enlarged edge is slidably retained in the channel when the elongated member is in the closed, retaining position. The enlarged edge is movable out of the channel when the elongated member is in the open, released position. A recovery gate is coupled to the first side guide and configured to direct the enlarged edge through the recovery opening and into the channel after the enlarged edge has moved out of the channel during a manual egress event.

In at least one embodiment of the smoke screen apparatus, the heat resistant film has a bottom edge and at least one bottom corner adjacent to the enlarged edge. On the bottom edge there can be a bottom bar that helps the screen deploy and also helps seal the bottom of the screen to the floor when deployed. Also, in at least one embodiment, at least one bottom corner of the screen has an anti-friction guide that is slidably engaged with the side guide as the film moves up and down between the deployed and retracted positions. The corner of the screen can also have a stiffening cover attached to the film material similar to those used on the clews of sails found on sail boats.

The smoke screen apparatus can have a header box with a motorized roller similar to those found on the M800 product from Smoke Guard. The motorized roller of the header box is where the flexible heat resistant film is stored when in the retracted position and not deployed. In at least one embodiment, the header box is coupled to a biasing spring to ensure that the enlarged side edge is guided into the elongated channel during deployment of the screen.

To help further ensure that the enlarged edge enters the elongated channel from a lateral direction, the header box may further comprise a non-motorized roller below the motorized roller, and this non-motorized roller may have a raised guide (i.e. larger diameter section on the roller) to help ensure that the enlarged side edge remains aligned with and enters the elongated channel of the side guide during deployment. This is accomplished since the guide pressing against the enlarged side edge keeps the film taut and does not allow the edge to drift laterally inward (i.e. away from the elongated channel).

Aspects of the present technology disclosed herein also provide a method of operating the screen apparatus comprising guiding the heat resistant film and enlarged side edge such that the film, in the retracted state, retains a controlled and repeatable profile on the motorized roll; deploying the film from a retracted position toward a deployed position when required by an environment where either smoke or fire migration may be a problem; allowing for a manual “push-through” style egress without physically lifting or any non-manual power when the heat resistant film is in the deployed position; automatically detecting a manual egress after deployment of the heat resistant film; and triggering a powered recovery algorithm to guide the film back into the retracted state.

### BRIEF DESCRIPTION OF THE DRAWINGS

FIG. 1(a) shows a schematic representation of Push-Through Egress from the inside of an elevator.

FIG. 1(b) shows a schematic representation of Push-Through Egress from the outside of an elevator.

FIG. 2 is a schematic isometric view of some of the basic components of a smoke screen apparatus in accordance with an embodiment of the present technology.

FIG. 3(a) is a partial cutaway view of one of the side guides with an enlarged side edge in an elongated channel in the side guide and a side portion of the flexible heat resistant film extending through the variable opening of the elongated channel.

FIG. 3(b) is a partial cutaway of the side guide of FIG. 3(a) as the flexible heat resistant film is being pulled away from the side guide, and the side guide's variable opening being opened to allow the enlarged side edge to exit the side guide.

FIG. 4(a) is a top down view of FIG. 3(b) with an elastomeric body as the biasing member rather than a spring.

FIG. 4(b) is an exploded view of the components of the side guide of FIGS. 3(a), 3(b), and 4(a), along with and the heat resistant film and the enlarged side edge releasably capturable in the side guide.

FIG. 5(a) is a perspective view of the clew portion of the screen at a bottom edge corner of the film.

FIG. 5(b) is an exploded view of the clew portion shown in FIG. 5(a).

FIG. 6 is a partial bottom isometric view of the headbox assembly with certain portions cut away to view the underlying elements.

FIG. 7 is an enlarged partial cutaway schematic view of the smoke screen apparatus with the heat resistant film in the retracted position in a ready state.

FIG. 8 is an enlarged partial cutaway schematic view of the smoke screen apparatus of FIG. 7 with the screen in a partially deployed position and with the enlarged side edge captured in the side guide.

FIG. 9 is an enlarged partial cutaway schematic view of the smoke screen apparatus with the heat resistant film in a breached condition with the enlarged side edge exterior of the side guide and with the screen in a partially retracted position during a recovery mode.

FIG. 10 is an enlarged partial isometric schematic view of the smoke screen apparatus of FIG. 9.

FIG. 11 is an enlarged partial cutaway schematic view of the smoke screen apparatus of FIG. 10 with the screen in the recovery mode approaching a stowed position with the enlarged side edge and clew positioned in a recovery guide for realignment with the elongated channel in the side guide.

FIG. 12 is a schematic flowchart of a recovery algorithm in accordance with an embodiment of the present technology.

### DETAILED DESCRIPTION

The present disclosure describes smoke barrier assemblies in accordance with certain embodiments of the present invention. Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Changes may be made to the particular embodiments and details disclosed herein without departing from such spirit and scope.

In showing and describing preferred embodiments in the appended figures, common or similar elements are referenced with like or identical reference numerals or are apparent from the figures and/or the description herein. The figures are not necessarily to scale, and certain features and certain views of the figures may be shown exaggerated in scale or in schematic in the interest of clarity and conciseness.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

The term “coupled” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function.

Also, the terms “including” and “comprising” are used herein and in the appended claims in an open-ended fashion, and thus should be interpreted to mean “including, but not limited to . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Preferred embodiments of the present disclosure thus offer advantages over the prior art and are well adapted to carry out one or more of the objects of this disclosure. However, the present disclosure does not require each of the components and acts described above and are in no way limited to the above-described embodiments or methods of operation. Any one or more of the above components, features and processes may be employed in any suitable configuration without inclusion of other such components, features and processes. Moreover, the present disclosure includes additional features, capabilities, functions, methods, uses, and applications that have not been specifically addressed herein but are, or will become, apparent from the description herein, the appended drawings, and claims.

The present technology now will be described more fully hereinafter with reference to the accompanying drawings, in which some preferred embodiments of the invention are shown. This technology may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

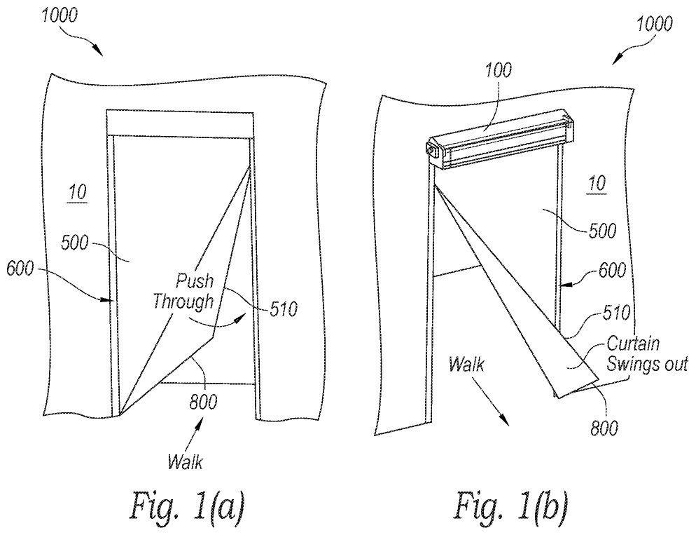

A graphic representation of push-through egress through a smoke screen apparatus 1000 in accordance with one or more embodiments of the present disclosure is shown in FIGS. 1(a) and 1(b). Most times during a fire event, those caught on the wrong side of a smoke barrier will not take time to observe or read any instructions regarding escape. The natural instinct is to go-through any barrier. A push-through egress is the preferred method from any Safety or Human Factors engineering perspective. All other egress designs on the market either require physical lifting of the barrier (via grab strap), or a difficult unlatching process to un-stick a large Velcro-like door seal. Neither method is obvious to a person during use, particularly during a fire or other emergency event, and will require more force than is optimal. Even though conventional egress systems can be selectively set-up to pass AC77 egress force requirements, the natural state of the devices does not lend themselves to operate in this selected state. To address these ease-of-use problems with current egress methods, the smoke screen apparatus 1000 in accordance with aspects of the present technology disclosed herein is configured for push-through egress and can be a unidirectional device intended to be installed outside an elevator frame with egress direction out of the elevator.

The operating premise of the present technology is to allow natural push-through egress, and the ability to automatically recover and reset to the ready state afterward. In order to achieve this, embodiments of the current technology may include the following elements:
a vertically operating smoke restrictive screen with an enlarged side edge feature that is capable of the required pressurization, yet can be extracted from the vertical edge capture guide upon a manual egress event;
a side guide with a releasing feature to allow the enlarged side edge feature to escape with the allowed egress force;
a sensor and associated logic to detect and control the recovery process;
a mechanical re-capture device to allow either manual or automatic recovery of the egressed screen and bottom bar assembly back to the retracted operational ready state; and
anti-friction, anti-wear, and damage resistant components in certain critical areas of the mechanism.

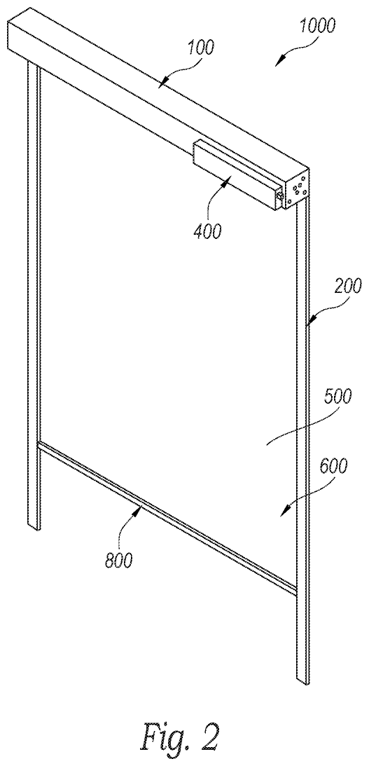

FIG. 2 is a schematic isometric view of some of the basic components of a smoke screen apparatus 1000 in accordance with an embodiment of the present technology. Smoke screen apparatus 1000 that incorporates the major subcomponents for this embodiment is illustrated. Each major subassembly or apparatus is noted numerically with greater detail of said claim in subsequent sections. For safety reasons, smoke screen apparatus 1000 must allow for manual egress through film 500 using a release mechanism that can automatically recover to the protective state after egress. Such manual egress is reliably achieved when a user simply puts sufficient pressure on film 500 (e.g., pushing generally normal to the film) from the exiting direction. This makes the egress process very intuitive and less likely to result in an incident involving a person not being able to exit through smoke screen apparatus 1000.

As shown in FIG. 2, smoke screen apparatus 1000 is mounted adjacent to a passageway 10, such as an elevator door or other doorway or passageway, through which a person would egress during an evacuation event or other egress situation. Smoke screen apparatus 1000 has a deployable smoke barrier assembly 600 with a flexible heat resistant film 500 that is movable relative to passageway 10 between a deployed position in which film 500 is covering passageway 10 and a retracted position in which film 500 is stowed and not covering passageway 10. A weighted bottom bar 800 is attached to the bottom edge portion of film 500 and is configured to engage the floor of passageway 10 when film 500 is in the deployed position. Film 500 in the deployed position is used to inhibit smoke from traversing through passageway 10 and/or across zone boundaries. Film 500 in the retracted position and when not deployed as a smoke barrier is housed in headbox assembly 100. Headbox assembly 100 in some embodiments is embedded into a ceiling or elevator frame (not expressly shown). Smoke screen apparatus 1000 has opposing side guides 200 connected to headbox assembly 100 and mounted to or otherwise positioned adjacent to sides of passageway 10. Each side guide 200 is configured to guide film 500 up and down between the deployed and retracted positions when controller assembly 400 receives a signal signifying an emergency event (e.g. from a local smoke detection device, or a signal input from the building fire control system).

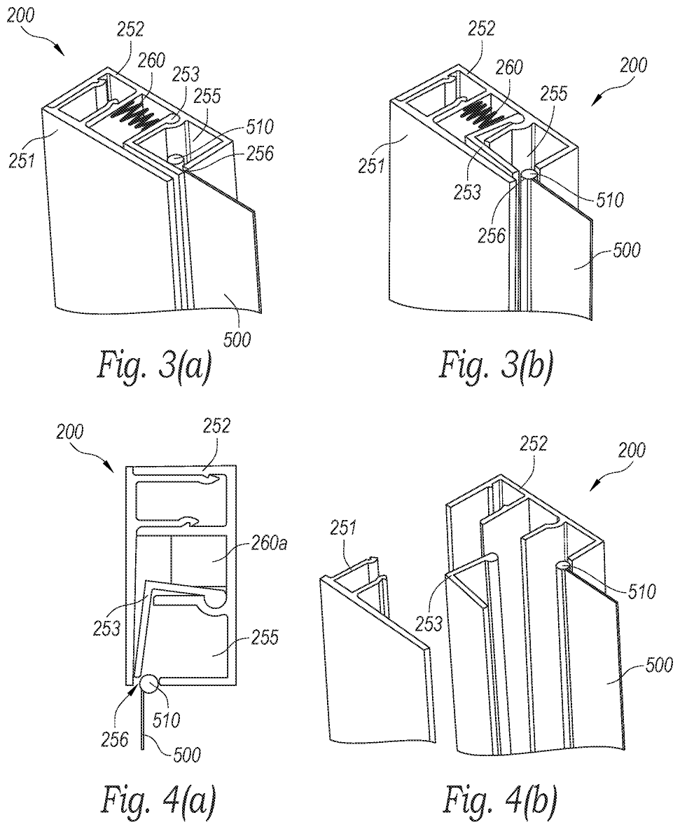

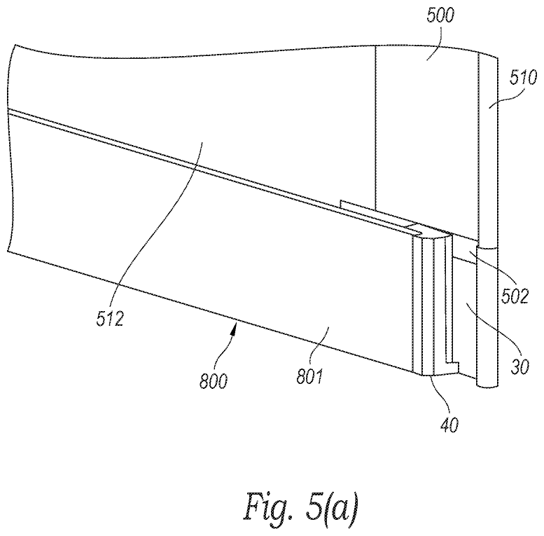

Controller 400 deploys smoke barrier assembly 600 by lowering film 500 and weighted bottom bar 800 out of headbox assembly 100. Turning now to FIGS. 3(a), 3(b), 4(a), and 4(b), illustrated film 500 is connected to at least one enlarged side edge 510 configured to slidably and releasably mate with one of the side guides 200. Film 500 in a preferred embodiment can be a polymer thin film with properties capable of meeting the requirements of ASTM E84, UL 1784, and AC77. In one implementation, this material is a polyimide film with a fiber reinforcing mesh available from Lamart Company under the trade name Orcofilm KN-20W. In other embodiments, film 500 could be a polyamide or polyethylene tetrafluoride film with or without a reinforcing fiber mesh. In certain embodiments enlarged edge 510 is a woven polymer rope with a round or off-round cross section, such that the cross-sectional thickness of enlarged edge 510 is substantially greater than the thickness of the side portion of film 500 connected to enlarged edge 510. In one implementation enlarged edge 510 is formed by a woven polyamide rope with an acrylic coating. In another embodiment, enlarged edge 510 is an extruded polymer cord or rod with a round or off-round cross section.

Enlarged edge 510 can be coupled to the side portion of film 500 in a variety of different ways. In at least one embodiment the heat resistant film utilizes an adhesive film often referred to as a pressure sensitive adhesive (PSA). In one embodiment, this adhesive film is VHB PSA from the 3M Corporation. In another embodiment, the side portion of film 500 is wrapped around enlarged edge 510 after enlarged edge 510 has been fully encased in PSA.

In some embodiments, enlarged edge 510 is a woven polymer rope, or a polymer coated wire rope. In other embodiments, enlarged edge 510 is the same material of film 500 but it is simply much thicker at the edge (e.g. by rolling it into a cylindrical shape). In some embodiments, enlarged edge 510 is attached to the lateral side portion of film 500 using pressure sensitive adhesives and a wrapping method to fix location and form of the edge element. In other embodiments, enlarged edge 510 is attached to the lateral side portion of film 500 using other commonly known attachment means such as sewing, clamps, hook and loop, staples, and so forth.

As can be seen in FIGS. 3(a), 3(b), 4(a), and 4(b), side guide 200 (i.e., in some embodiments the door frame itself) is an assembly of several mating parts configured to slidably, yet releasably, capture enlarged edge 510 of heat resistant film 500, so enlarged edge 510 and associated side portion of film 500 can slide vertically within side guide 200 as film 500 moves between the retracted and deployed positions. The interface between side guide 200 and enlarged edge 510 securely retains film 500 at the edge of the passageway 10 (FIG. 1) so as to securely seal passageway 10 and block smoke and/or fire migration through the passageway when film 500 is in the deployed position. The assembly of several mating parts forming side guide 200, however, is configured to enable enlarged edge 510 and the edge portion of film 500 to release from side guide 200 upon application of a force generally normal to film 500 (e.g., when a person pushes on film 500 in the deployed position), so as to cause a large portion of film 500 to swing and move forwardly or rearwardly away from side guide 200 in the direction of egress forming a temporary egress opening that allows manual egress between containment zones as desired.

Side guide 200 of the illustrated embodiment includes an elongated channel 255 designed to have a variable sized opening 256 at least partially defined by at least one moveable elongated member 253 spaced apart from the forward edge of guide base 252. Side guide 200 may also be comprised of other component parts such as shown in FIGS. 3(a), 3(b), 4(a), and 4(b), including guide base 252, guide cover 251 and biasing member or biaser 260. In at least one embodiment, moveable elongated member 253 is pivotably attached to guide base 252 and movable between a closed, retaining position and an open, released position. Elongated member 253 is biased into the closed, retaining position by biaser 260 that minimizes the size of variable sized opening 256 under normal conditions to a width greater than the thickness of the side portion of film 500 but less than the thickness of enlarged edge 510. Accordingly, when film 500 is in the normal deployed position and/or moving between the retracted and deployed positions, enlarged side edge 510 is slidably captured within side guide 200 with the side portion of film 500 extending through opening 256.

Biaser 260 is strong or stiff enough to hold movable elongated member 253 in the closed, retaining position when film 500 is being deployed and is in the deployed position. Biaser 260 is also strong or stiff enough to withstand pressure forces applied to film 500 from smoke, airflow, etc., during a fire or other emergency event. Elongated member 253 and biaser 260 are configured to allow elongated member 253 to overcome the biasing force from biaser 260 and pivot away from the closed, retaining position to the open, released position when a sufficient force is applied to film 500 so as to pull enlarged edge 510 laterally inwardly and against elongated member 253. Under this force, elongated member 253 pivots relative to guide base 252, thereby moving to the open, released position. When elongated member 253 is in the open, released position, the width of variable sized opening 256 is enlarged to a width greater than the thickness of enlarged edge 510, such that enlarged edge 510 and the side portion of film 500 can disengage and move laterally inwardly away from side guide 200. Once disengaged from side guide 200, a person can push at least a portion of film forwardly or rearwardly away from side guide 200 to manually form an egress opening through which the person can pass.

In FIGS. 3(a) and 3(b) biaser 260 is a spring. In FIG. 4(a), biaser 260 is an elastomeric body that is compressible but then returns to its original shape. In another embodiment (not expressly shown) biaser 260 is comprised of a tempered steel band with a formed profile tuned to enable specific egress force and pressurization requirements. In either embodiment, biaser 260 is tuned to allow proper egress forces as well as pressure retention capabilities so as to control movement of elongated member 253 between the closed, retaining position and the open, released position. In at least one embodiment the egress force will be approximately 151 bs egress force and 0.3″ water gage pressurization.

The minimized size of opening 256, when elongated member 253 is in the closed, retaining position under normal conditions as shown in FIG. 3(a), allows film 500 and enlarged side edge 510 to move freely up and down elongated channel 255 as film 500 moves between the retracted and deployed positions, but does not allow enlarged edge 510 to slip out of channel 255 through opening 256. Also, channel 255 is sized and designed such that enlarged edge 510 slides easily up and down in elongated channel 255 under normal opening and closing of smoke barrier assembly 600 across passageway 10 (FIG. 1). Film 500 and enlarged edge 510 maintain a seal as they are guided during deployment into side guide 200 and elongated channel 255.

The side guide 200 described above can be used on only one side of the door frame or passageway 10. In some embodiments it may be preferred that both sides of the door frame or passageway 10 have identical side guides 200 that allow film 500 to be detached from either side guide 200 upon pushing on or otherwise applying a sufficient manual egress force against film 500. In some embodiments, side guide 200 (and a corresponding guide on the opposite side) may be installed directly into the metallic door frames of an elevator (not expressly shown) or other door frames of ingress and egress passageways or portals.

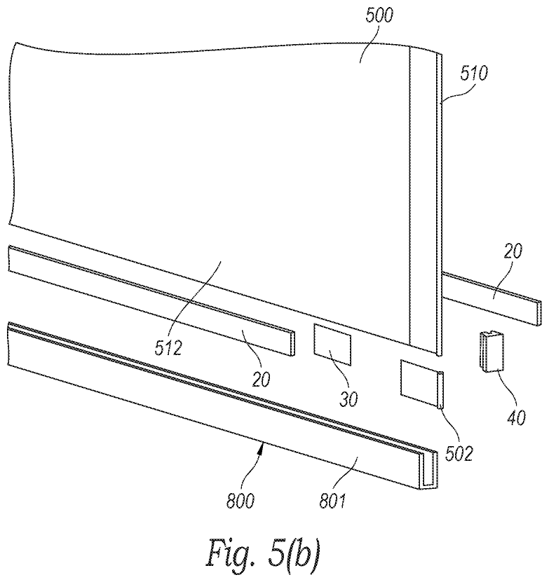

Turning now to FIGS. 5(a) and 5(b), one can see more details on bottom bar 800 connected to the bottom edge portion of film 500, such that bottom bar 800 moves up and down relative to side guides 200 as film 500 moves between the deployed and retracted positions. Bottom bar 800 is weighted to ensure both sealing against the floor when film 500 is in the deployed position, and flush finish in headbox assembly 100 when in the stowed position. FIG. 5(b) is a partially exploded view of the bottom of smoke barrier assembly 600 and FIG. 5(a) is a perspective view. In the illustrated embodiment, bottom bar 800 has a body 801 formed by a U-shaped channel. Internal stiffening bars 20 are coupled to opposing sides of the bottom edge portion 512 of film 500 using either adhesives, tacking, or other methods of attaching a metallic bar to a flexible fabric type material.

In at least one embodiment, each stiffening bar 20 is formed by a conventional steel bar approximately 0.5 inches thick and 1.5 inches wide. Stiffening bar 20 in at least one embodiment is coupled to the bottom of film 500 by 3M Pressure Sensitive adhesive. Body 801 of bottom bar 800 of the illustrated embodiment is a metal U-channel sized and shaped to slip over both of stiffening bars 20 (stiffening bars 20 are not visible in FIG. 4(a) since they are covered by bottom bar 800). In one embodiment, bottom bar 800 is a commercially available aluminum channel, although other materials can be used. The width of bottom bar 800 and stiffening bars 20 are less than the full width of film 500, so neither stiffening bars 20 nor bottom bar 800 extend laterally to the outermost edges of film 500 and interfere with enlarged edge 510. This configuration allows film 500 and enlarged edge 510 to move up and down as a unit through the full length of guide(s) 200.

In the illustrated embodiment, at least one of the bottom corners 502 of film 500 is stiffened to ensure that manual egress pressure on film 500 causes film 500 and enlarged edge 510 to pivot elongated member 253 of side guide 200 to the open, released position as discussed above, so enlarged edge 510 will pull away and disengage from side guide 200. When enlarged edge 510 is disengaged, force on film 500 will swing film 500 and bottom bar 800 forwardly or rearwardly relative to side guide 200 to form the egress opening, so that a person may walk through the passageway 10. A stiffening member 30 is used to retain the film's bottom corner 502 or clew-like configuration inside the side guide's channel, yet allows enough compliance for bottom bar 800 to be moved forwardly or rearwardly away from side guide 200 in the event of manual egress.

As shown in FIG. 5(a), stiffening member 30 is closely fitted (or crimped) over both sides of the bottom edge portion 512 of film 500 and enlarged edge 510. Stiffening member 30 can be a preformed rigid member made of a thin, hardened metal strip. It may be coupled to film 500 and enlarged edge 510 using both crimping and/or adhesive. In one embodiment, stiffening member 30 is a custom-formed crimp sleeve made of #510 Bronze or half hard Stainless Steel.

In one embodiment, the bottom corner 502 of film 500 has anti-friction member 40. Anti-friction member 40 is sized, shaped, and positioned so that it is slidably engaged with guide 200 (FIG. 2) to allow film 500 and enlarged edge 510 to move up and down guide 200 more easily. In at least one embodiment, anti-friction member 40 is a U-shaped member made from nylon, UHMWPE, or acetal. It can be inserted between bottom bar 800 and stiffener 30 and then the entire clew assembly can be coupled together using pins or other fasteners. In one embodiment stiffening member 30 is made of polylactic acid (PLA) via stereolithography. In some embodiments heat resistant film 500 and weighted bottom bar 800 are attached to one another using pressure sensitive adhesives and a forming swage press.

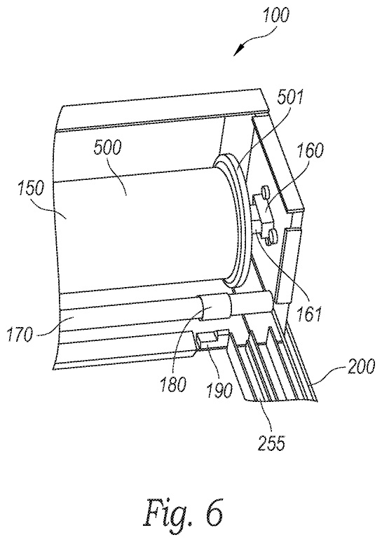

FIG. 6 shows a partial view of headbox assembly 100 with both controller assembly 400, a controller enclosure, and front wall not shown so as to illustrate the components within headbox assembly 100. Headbox assembly 100 contains a roller 150 upon which film 500 winds and unwinds when film 500 is moved between the deployed and retracted positions. In the illustrated embodiment, roller 150 is a mechanized or motorized roller coupled to a drive motor that, upon activation, rotates roller 150. The electronics and the drive motor of the smoke screen apparatus 1000 are all well known in the art and are not described in detail herein. These parts of the smoke screen apparatus 1000 described herein can be found commercially on the M800 product from Smoke Guard of Boise Idaho and are described to a certain extent in U.S. Pat. Nos. 5,195,594 and 5,383,510 (which are incorporated herein by reference).

As shown in FIG. 6, side guide 200 is positioned with its upper end portion in or adjacent to headbox assembly 100. For purposes of illustration, the guide cover 251, biaser 260, and elongated member 253 are not shown in FIG. 6; only the guide base 252 is shown in order to view elongated channel 255. Motorized roller 150 of the illustrated embodiment includes a hollow cylinder that rotates around axle 161 and bearing 160. Motorized roller 150 has a motor (not visible since it is inside of mechanized roller 150) that can be activated by various sensors and controller 400 to rotate axle 161 in one of two directions (i.e., unrolling film 500 toward the deployed position or rolling film 500 onto mechanized roller 150 toward the retracted position).

Headbox assembly 100 further includes non-motorized roller 170 below motorized roller 150. The illustrated non-motorized roller 170 has cylindrical guide 180 configured to align the side edge portion of film 500 and enlarged edge 510 generally in vertical alignment with side guide 200 as film 500 rolls onto roller 150. Cylindrical guide 180 helps assure that enlarged edge 510 remains in and/or enters elongated channel 255 of side guide 200 at the top of side guide 200. Cylindrical guide 180 has a larger diameter than non-motorized roller 170, and cylindrical guide 180 is configured to engage film 500 and/or enlarged edge 510 as motorized roller 150 is rotating, such that enlarged side 510 cannot migrate toward the center of headbox assembly 100. This helps keeps enlarged edge 510 aligned with elongated channel 255 of side guide 200. Accordingly, cylindrical guide 180 controls the roll-up profile of film 500 and enlarged edge 510 for proper and consistent deployment and retraction of film 500.

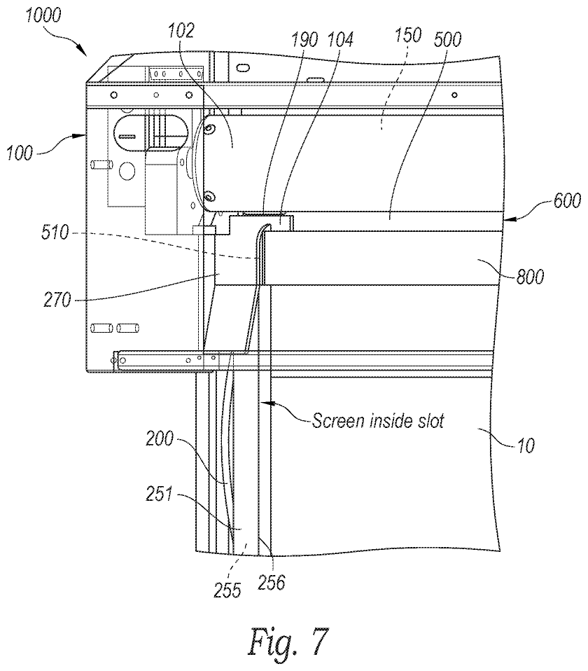

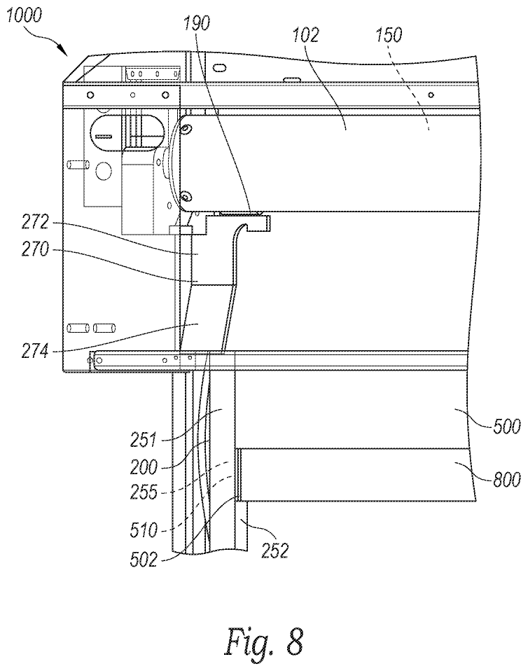

FIG. 7 is an enlarged partial cutaway schematic view of the smoke screen apparatus 1000 with film 500 shown in the retracted position in a ready state. In this arrangement, bottom bar 800 is positioned just below the film rolled onto roller 150 and contained within a roller shroud 102. Bottom bar 800 is positioned against a stop member 104 contained within the headbox assembly 100. A sensor 190 can be used on or adjacent to the stop member 104 or bottom bar 800 to detect when bottom bar 800 engages stop member 104, thereby indicating that film 500 is in the retracted position. Stop member 104 also blocks bottom bar 800 from getting rolled too far up or onto roller 150, such that bottom bar 800 and the associated enlarged edge 510 will stay aligned with the top of side guide 200. When smoke screen apparatus 1000 is activated and film 500 is moved from away from the stowed positions to an intermediate position as shown in FIG. 8, the edge portion of film 500 and enlarged edge 510 move within the side guide's channel 255. In this configuration, the side guide's elongated member 253 (FIG. 3A) remains in the closed, retaining position with enlarged edge 510 slidably captured in channel 255. The film's stiffened bottom corner 502 and bottom bar 800 provides structural stiffness at the sides of film 500 so enlarged edge 510 smoothly and easily travels within side guide's channel 255 during normal movement between the deployed and retracted positions.

When film 500 is in the deployed position extending across passageway 10 (FIG. 1), a person can manually egress through the smoke barrier assembly by physically pushing against film 500 in a generally normal direction in an area in the vicinity of side guide 200. When the person pushes film 500 with a sufficient force, the biasing force of side guide's biaser 260 is overcome, and elongated member 253 will pivot to the open, released position and at least a portion the enlarged edge 510 will be pulled out of side guide 200. The film 500 and bottom bar 800 can then be moved (e.g., pivoted) forwardly or rearwardly by the person to create an egress opening next to side guide 200 sufficiently large to allow the person to pass through the opening. After the person has moved through the egress opening and releases smoke barrier assembly 600, film 500 and bottom bar 800 will swing back to close the egress opening. In this situation, the film's enlarged edge 510 will be positioned adjacent to the exterior of side guide 200 with enlarged edge 510 and stiffened bottom corner 502 no longer captured in channel 255.

The smoke screen apparatus 1000 can have sensors, such as proximity sensors, pressure sensors, or other suitable sensors coupled to side guide 200 to detect a post egress condition in which enlarged edge 510 has been released from side guide 200. In at least one embodiment, smoke screen apparatus 1000 utilized an encoder that determines the position of screen 600 at and between the retracted and stowed positions. Proximity sensors are provided in or adjacent to the bottom portion of side guide to determine whether enlarged edge 510 is within channel 255 or if enlarged edge 510 has been pulled out of side guide 200, such as due to a manual egress event or the like. Other sensors can be used to monitor the position of enlarged edge 510 relative to side guide 200 or to monitor the position of enlarged edge 510 or film 500 relative to side guides 200 and passageway 10. The sensor(s) can provide a signal to controller 400, such as when enlarged edge 510 is no longer within channel 255, and controller 400 can initiate a recovery mode post egress in which motorized roller 150 is activated to retract film 500 and bottom bar 800 from the deployed position to the retracted position.

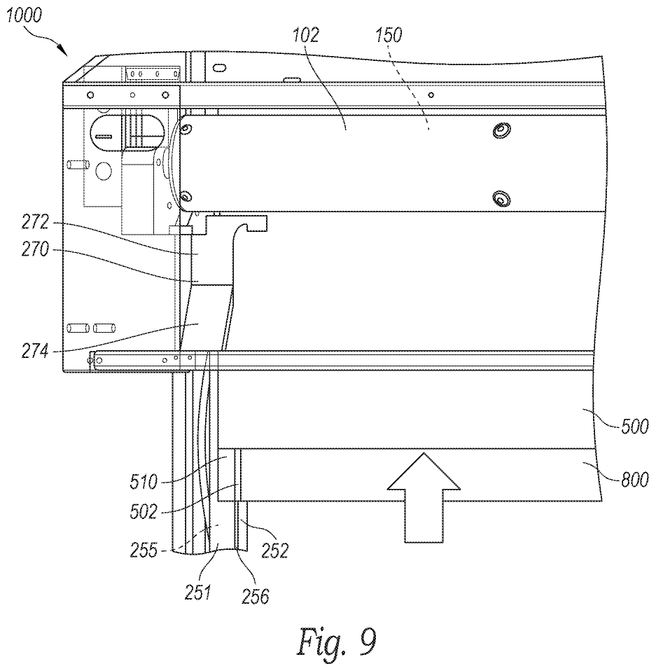

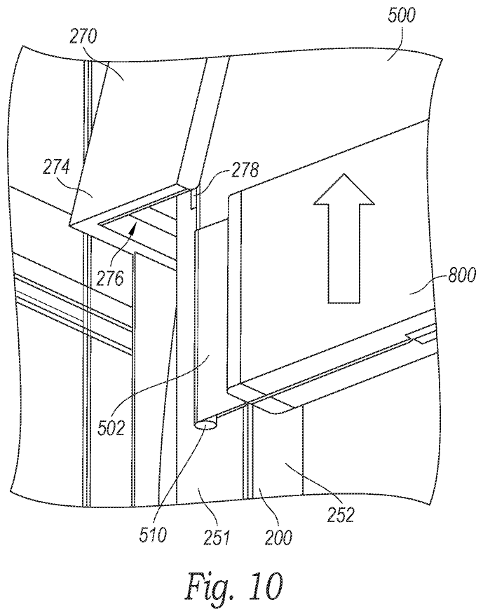

FIG. 9 is an enlarged partial cutaway schematic view of smoke screen apparatus 1000 with film 500 in a breached or post egress condition with enlarged edge 510 exterior of side guide 200 and with film 500 in a partially retracted position during a recovery mode in which film 500 is moved back toward the stowed position. FIG. 10 is an enlarged view of the screen apparatus of FIG. 9 at the top portion of side guide 200. Side guide 200 is configured at its top portion to reposition enlarged edge 510 back into channel 255 within side guide 200. A recovery gate 270 is provided at the top of side guide 200 within header box assembly 100. Recovery gate 270 has an attachment plate 272 attached to side guide 200, such that attachment plate 272 is substantially coplanar with the front edge of guide base 252. A flared alignment leg 274 is connected at its top end to attachment plate 272. Flared alignment leg 274 extends downwardly and forwardly away from attachment plate 272 at an angle, so the lower portion of alignment leg 274 is spaced apart from guide cover 251 to form a wedge-shaped space 276 between alignment leg 274 and guide base 252. As film 500 approaches the retracted position during recovery mode, enlarged edge 510 is drawn upwardly into the wedge-shaped space.

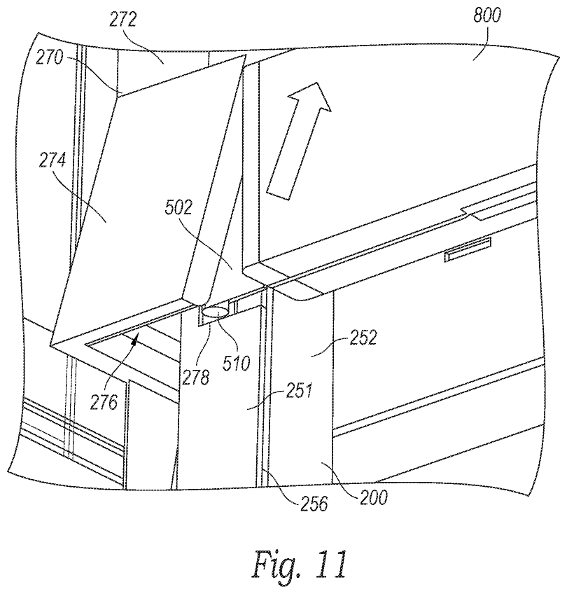

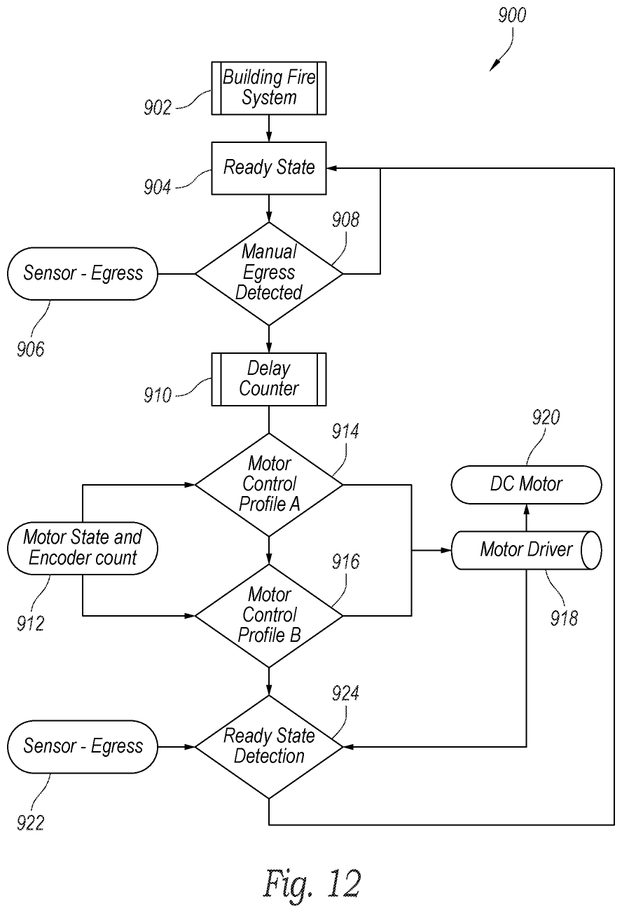

FIG. 11 is an enlarged partial cutaway schematic view of the screen apparatus of FIG. 10 with heat resistant film 500 in the recovery mode approaching the stowed position. Film's enlarged edge 510 and stiffened bottom corner 502 are shown positioned in recovery gate 270 for realignment or recovery translation back into slot 255 in side guide 200. In the illustrated embodiment, guide cover 251 of side guide 200 has a recovery opening 278 positioned within the wedge-shaped space 276 under recovery gate's alignment leg 274. Recovery opening 278 is positioned in vertical alignment with enlarged edge 510, and recovery opening 278 provides access into channel 255 of side guide 200 at the top portion of guide base 252.

As film 500 is retracted during recovery mode and approaches the retracted position, film's stiffened bottom corner 502 and enlarged edge 510 are drawn into the recovery gate's wedge-shaped space 276 and over recovery opening 278. Alignment leg 274 of recovery gate 270 pushes enlarged edge 510 through recovery opening 278 and back into channel 255 within guide base 252, such that the edge portion of film 500 adjacent to enlarged edge 510 is also aligned with the variable sized opening 256. When film 500 reaches the fully retracted position during recovery mode, recovery gate 270 has repositioned enlarged edge 510 through recovery opening 278 and into channel 255 within guide base 252, such that the edge portion of film 500 is aligned with variable sized opening 256. One or more sensors can be provided in or adjacent to side guide 200, including adjacent to the top of side guide 200 to detect whether film 500 and enlarged edge 510 are properly positioned within channel 255 and in a ready condition for subsequent deployment.

In at least one embodiment, attachment plate 272 of recovery gate 270 can be positioned against the forward edge of guide base 252 at the top of side guide 200 within headbox 100, such that attachment plate 272 forms a cover over channel 255 and is immediately adjacent to the film's stiffened bottom corner 502 when film is in the retracted position. Recovery gate's alignment leg 274 and the recovery opening 278 are sized and positioned so that, when film 500 is deployed and moved out of the retracted position, attachment plate 272 maintains vertical alignment of enlarged edge 510 in channel 255 and blocks enlarged edge 510 and bottom corner 502 from moving forwardly out of channel 255 and out of vertical alignment with variable sized opening 256. Accordingly, when film 500 is deployed from the retracted position, either during normal operation or after recovery mode, recovery gate 270 helps ensure that enlarged edge 510 and film 500 are in the ready state and will slide smoothly along channel 255 with film 500 extending through opening 256 as film 500 moves toward the deployed position.

FIG. 14 is a schematic flowchart of a recovery algorithm 900 in accordance with an embodiment of the present technology. Post Egress Recovery can be achieved through two methods: manual and automatic. In some operational environments, it is required to have manual recovery performed by trained service personnel. Since the device is supplied with battery backup, and this battery is auto-maintained by the controller algorithm with alarms, even in the absence of AC power service, personnel can use a remote service module which allows manual actuation of recovery algorithms. In most cases, however, smoke screen apparatus 1000 will be configured to auto-recover from a manual egress event. Controller 400 will execute a recovery algorithm 900 via the controller or other computing device if the bottom edge sensor is activated by a manual egress after film 500 is deployed, such as when the building fire system is triggered.

The computing devices on which the disclosed control and/or recovery process can be implemented may include (but does not have to include) a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the technology, e.g., a computer-readable medium that contains the instructions. In addition, the instructions, data structures, and message structures may be stored or transmitted via a data transmission medium, such as a signal on a communications link and may be encrypted. Non-transitory computer-readable media include tangible media such as storage media, hard drives, CD-ROMs, DVD-ROMS, and memories such as ROM, RAM, and Flash memories that can store instructions. Signals on a carrier wave such as an optical or electrical carrier wave are examples of transitory computer-readable media. Furthermore, “computer-readable devices” includes input, output, storage, and other devices but does not include transitory, propagating signals. Various communications links may be used, such as the Internet, a local area network, a wide area network, a point-to-point dial-up connection, a cell phone network, and so on.

The disclosed systems may be described in the general context of computer-executable instructions, such as program modules, executed by one or more computers or other devices. Generally, program modules include routines, programs, objects, components, data structures, and so on, that perform particular tasks or implement particular abstract data types. Typically, the functionality of the program modules may be combined or distributed as desired in various embodiments.

Embodiments of the control technology described herein may take the form of computer-executable instructions, including routines executed by a programmable computer. Those skilled in the relevant art will appreciate that aspects of the technology can be practiced on computer systems other than those shown and described herein. Embodiments of the technology may be implemented in and used with various operating environments that include on-board computers, server computers, handheld or laptop devices, multiprocessor systems, microprocessor-based systems, programmable consumer electronics, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any data processor and can include Internet appliances and handheld devices (including palmtop computers, wearable computers, cellular or mobile phones, multi-processor systems, processor-based or programmable consumer electronics, network computers, mini computers and the like). Information handled by these computers can be presented at any suitable display medium as needed.

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the technology. For example, various systems may transmit data structures and other information using various protocols, such as the hypertext transfer protocol (HTTP), the transmission control protocol (TCP), the OpenTherm protocol, the ZigBee protocols, and so on.

As seen in FIG. 14, the building fire system (block 902), which includes smoke screen apparatus 1000, during operation is typically in a ready state (block 904). If the building fire system or other control system coupled to the smoke screen apparatus 1000 indicates a fire or other suitable emergency condition, controller 400 (FIG. 2) will be activated to move film 500 from the stowed position to the deployed position. The sensors, including the bottom edge sensor and/or other egress sensors (block 906) are monitored to determine whether the film's enlarged edge 510 (FIG. 5) is exterior of side guide 200 (FIG. 1), indicating that a manual egress event has occurred (block 908). If a manual egress event has not occurred, the program returns to block 904. If a manual egress has occurred, a delay counter is activated (block 910). After a pre-determined delay to allow subsequent egress events, the controller will begin a screen retract sequence with a specific retraction rate profile. The retraction rate profiles, including the speed and sequence for moving the smoke barrier assembly 600 to the retracted position, can be different for different sized smoke barrier assemblies 600. Each retraction rate profile has motor control instructions used by controller 400 for raising film 500. The recovery algorithm of the illustrated embodiment can be used with a range of different smoke barrier assemblies, each of which corresponds to one of the motor profiles. The appropriate rate or motor control profile for the particular smoke barrier assembly 600 is selected during set up.

Following activation of the delay counter at block 908, recovery algorithm 900 determines the drive motor state and encoder information at block 912 to determine the particular position of the film relative to the side guides 200 and relative to the retracted and deployed position. Recovery algorithm 900 also determines which motor control profile applies for the particular smoke barrier assembly 600 used with the smoke screen apparatus 1000. For example, recovery algorithm 900 determines at blocks 914 and 916 if motor control profile A or motor control profile B is to be used to raise smoke barrier assembly 600. Although the flow chart of FIG. 14 only illustrates two motor control profiles, recovery algorithm 900 can include more than two motor control profiles for controlling the drive motor for the smoke barrier assembly 600. The relevant motor control profile is used to control the motor driver (block 918) and the DC motor (block 920) to raise film 500 at the appropriate speed and sequence to move film 500 to the retracted position and to return enlarged edge 510 into side guide in the ready state for subsequent deployment. At block 922, one or more sensors are monitored to determine whether film 500 is at the fully retracted position and in the ready state (block 924). When the ready state has been detected at block 922, recovery algorithm returns to block 904. At the end of this algorithm, the system will be in the ready state. If the building fire or emergency system is still activated, film 500 will re-deploy to the protective state to control smoke movement. If the alarm has been cleared, film 500 will remain in the retracted position and in the ready state.

Having thus described in detail a preferred selection of embodiments of the present invention, it is to be appreciated and will be apparent to those skilled in the art that many physical changes could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

I/We claim:

1. A smoke screen apparatus to prevent smoke migration from an area comprising:
a side guide having an elongated channel at least partially defined by at least a guide base and one moveable elongated member;
a screen having flexible heat resistant film and an enlarged side edge coupled to the film and that is sized to fit inside the elongated channel when the smoke screen is deployed; and
the smoke screen apparatus configured to allow manual push-through egress from the area when the screen is deployed when a sufficient pressure is exerted on the flexible heat resistant film so that the enlarged edge of the screen causes the elongated moveable member to pivot relative to the guide base by a distance that allows the enlarged edge to exit the elongated channel.

2. The smoke screen apparatus of claim 1 wherein the heat resistant film has a bottom edge portion and at least one bottom corner, and wherein the screen has a bottom bar coupled to the bottom edge, and the at least one bottom corner has an anti-friction guide, and a stiffening element.

3. The smoke screen apparatus of claim 1 wherein screen is movable between a retracted position and a deployed position, the enlarged side edge is substantially vertical when the screen is in the deployed position.

4. The smoke screen apparatus of claim 1 wherein elongated member is movable relative to guide base between a closed, retaining position and an open, released position, wherein the enlarged edge is slidably retained in the channel when the elongated member is in the closed, retaining position, and wherein the enlarged edge is movable out of the channel when the elongated member is in the open, released position capture.

5. The smoke screen apparatus of claim 4 wherein the side guide has a biasing member coupled to the elongated member and configured to urge the elongated member toward the closed, retaining position.

6. The smoke screen apparatus of claim 1, further comprising a recovery gate coupled to the side guide, the side guide having a recovery opening in communication with the channel, and the recovery gate is configured to direct the enlarged edge through the recovery opening and into the channel after the enlarged edge has moved out of the channel during a manual egress event.

7. The smoke screen apparatus of claim 1, further comprising a headbox assembly coupled to the side guide, wherein the flexible heat resistant film is stored within the headbox assembly when not deployed and wherein the headbox assembly is coupled to a recovery member configured to assure that the enlarged side edge is guided into the elongated channel during deployment of the screen

8. The smoke screen apparatus of claim 1, further comprising a header box coupled to the side guide, wherein the flexible, heat resistant film is stored within the header box when not deployed, the header box having a motorized roller that holds the flexible, heat resistant film when not deployed and deploys the film by unrolling the film off the roller when activated.

9. The smoke screen apparatus of claim 8 wherein the header box further comprises a non-motorized roller below the motorized roller, said non-motorized roller having a guide configured to align the enlarged side edge for entry the elongated channel of the side guide when the heat resistant film is moving from a retracted position toward a deployed position.

10. A smoke screen apparatus, comprising:
a headbox assembly;
a smoke screen coupled to the head box assembly, the smoke screen having flexible heat resistant film and at least one enlarged side edge coupled to a side portion of the film, the smoke screen being movable between deployed and retracted positions, the smoke screen being contained in the headbox assembly when in the retracted position; and
opposing side guides adjacent to the headbox assembly and coupled to the smoke screen, the side guides engaging the smoke screen during movement to the deployed position, at least a first side guide having a guide base with an elongated channel therein configured to slidably receive the enlarged side edge, the first side guide having a moveable elongated member connected to the guide base and at least partially covering the elongated channel to releasably retain the enlarged side edge portion therein during movement of the smoke screen between the stowed and retracted positions, wherein elongated member is movable relative to guide base between a closed, retaining position and an open, released position, the enlarged edge is slidably retained in the channel when the elongated member is in the closed, retaining position, and wherein the enlarged edge is movable out of the channel when the elongated member is in the open, released position capture.

11. The smoke screen apparatus of claim 10, wherein the smoke screen apparatus is configured to allow manual push-through egress therethrough when the smoke screen is in the deployed position and when a sufficient pressure is exerted on the flexible heat resistant film so that the enlarged edge of the screen causes the elongated moveable member to pivot relative to the guide base by a distance that allows the enlarged edge to exit the elongated channel.

12. The smoke screen apparatus of claim 10, wherein the heat resistant film has a bottom edge portion and at least one bottom corner, and wherein the smoke screen has a bottom bar coupled to the bottom edge, and the at least one bottom corner has an anti-friction guide, and a stiffening element.

13. The smoke screen apparatus of claim 10 wherein the side guide has a biasing member coupled to the elongated member and configured to urge the elongated member toward the closed, retaining position.

14. The smoke screen apparatus of claim 10, further comprising a recovery gate coupled to the side guide, the side guide having a recovery opening in communication with the channel, and the recovery gate is configured to direct the enlarged edge through the recovery opening and into the channel after the enlarged edge has moved out of the channel during a manual egress event.

15. The smoke screen apparatus of claim 10 wherein the headbox assembly has a motorized roller that holds the flexible heat resistant film when the smoke screen is in the retracted position and deploys the smoke screen by unrolling the film off the roller when activated.

16. The smoke screen apparatus of claim 15 wherein the headbox assembly further comprises a non-motorized roller below the motorized roller, the non-motorized roller having a guide configured to align the enlarged side edge for entry the elongated channel of the first side guide when the heat resistant film is moving from the retracted position toward the deployed position.

17. A smoke screen apparatus, comprising:
a headbox assembly;
a smoke screen coupled to the head box assembly, the smoke screen having flexible heat resistant film and at least one enlarged side edge coupled to a side portion of the film, the smoke screen being movable between deployed and retracted positions, the smoke screen being contained in the headbox assembly when in the retracted position;
opposing side guides adjacent to the headbox assembly and coupled to the smoke screen, the side guides engaging the smoke screen during movement to the deployed position, at least a first side guide having a guide base with an elongated channel therein configured to slidably receive the enlarged side edge, the first side guide having a moveable elongated member connected to the guide base and at least partially covering the elongated channel to releasably retain the enlarged side edge portion therein during movement of the smoke screen between the stowed and retracted positions, wherein elongated member is movable relative to guide base between a closed, retaining position and an open, released position, a biasing member being coupled to the elongated member and configured to urge the elongated member toward the closed, retaining position, the first side guide having a recovery opening in communication with the channel, the enlarged edge is slidably retained in the channel when the elongated member is in the closed, retaining position, and wherein the enlarged edge is movable out of the channel when the elongated member is in the open, released position capture; and
a recovery gate coupled to the first side guide and configured to direct the enlarged edge through the recovery opening and into the channel after the enlarged edge has moved out of the channel during a manual egress event.

18. The smoke screen apparatus of claim 17, wherein the smoke screen apparatus is configured to allow manual push-through egress therethrough when the smoke screen is in the deployed position and when a sufficient pressure is exerted on the flexible heat resistant film so that the enlarged edge of the screen causes the elongated moveable member to move relative to the guide base to the open, released position that allows the enlarged edge to exit the elongated channel.

19. The smoke screen apparatus of claim 18, wherein the recovery gate has an angled alignment leg adjacent to the recovery opening, the alignment leg projecting away from the guide base and configured to direct at least a portion of the enlarged edge through the recovery opening and into the channel after the enlarged side edges have moved out of the channel when the elongated member is in the open, released position, and when the smoke barrier is moved to the retracted position during a recovery mode.

20. The smoke screen apparatus of claim 17 wherein the headbox assembly has a motorized roller that holds the flexible heat resistant film when the smoke screen is in the retracted position and deploys the smoke screen by unrolling the film off the roller when activated, and a non-motorized roller is adjacent to the motorized roller, the non-motorized roller having a guide configured to align the enlarged side edge for entry the elongated channel of the first side guide when the heat resistant film is moving from the retracted position toward the deployed position.
